(19) United States
(12) Patent Application Publication
(10) Pub. No.: US 2014/0191554 A1
(43) Pub. Date: Jul. 10, 2014

(54) POUR IN PLACE HEADREST

(71) Applicant: FORD GLOBAL TECHNOLOGIES, LLC, Dearborn, MI (US)

(72) Inventors: Aldo Dublan, Cuautitlan Izcalli (MX); Robert Someschan, Haan (DE)

(73) Assignee: FORD GLOBAL TECHNOLOGIES, LLC, Dearborn, MI (US)

(21) Appl. No.: 13/737,685

(22) Filed: Jan. 9, 2013

(51) Int. Cl. B60N 2/48; B29C 45/14

(52) U.S. Cl. CPC B60N 2/4808; B29C 45/14
USPC 297/410; 264/46.4; 297/391

(57) ABSTRACT

A vehicle headrest includes a cover stock shell that encloses an injection cavity. A hollow support structure has a first portion that extends within the injection cavity and includes a dispensing feature. A second portion of the support includes a securing feature for engaging an attachment structure. A foam substrate is disposed within the injection cavity. The foam substrate is delivered to the injection cavity within the support structure and through the dispensing feature.

### FIELD OF THE INVENTION

The present invention generally relates to a vehicle headrest, and more particularly to a pour in place headrest.

### BACKGROUND OF THE INVENTION

Vehicle seating assemblies commonly include a headrest coupled with an upper portion of a seatback to support a passengers head. In some instances, these headrests include a cushion material that is typically injected into the headrest via an injection aperture in a cover material of the headrest. The injection apertures can be visually unappealing and frequently require additional processes and materials to repair or conceal these injection apertures.

### SUMMARY OF THE INVENTION

According to one aspect of the present invention, a vehicle headrest includes a cover stock shell that encloses an injection cavity. A hollow support has a first portion that extends within the injection cavity and includes a dispensing feature. A second portion includes a securing feature for engaging an attachment structure. A foam substrate is disposed within the injection cavity. The foam substrate is delivered to the injection cavity within the hollow support and through the dispensing feature.

According to another aspect of the present invention, a vehicle headrest includes a body portion which encloses a cavity and has a post hole. A hollow support post extends through the post hole, defining a first portion within the cavity and a second portion that engages an attachment structure. A foam substrate is injected into the cavity via the support post to occupy the injection cavity in a predetermined shape.

According to another aspect of the present invention, a method for forming a headrest includes providing a cover stock shell that encloses a cavity and has a post hole. A hollow support is inserted through the post hole and into the cavity to define a first portion that has a dispensing aperture within the cavity. A second portion of the hollow support is configured to engage an attachment structure and has a distal end with an injection aperture. A foam substrate is injected into the cavity via the support to form a body portion with a predetermined shape.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a top perspective view of a vehicle seating assembly having a vehicle headrest, shown in a vehicle;

FIG. 2 is a front perspective view of the vehicle headrest, having a portion of a hollow support shown in dashed lines;

FIG. 3 is a front elevational view of the vehicle headrest having a portion of the hollow support shown in dashed lines;

FIG. 4 is a cross-sectional side view of the vehicle headrest taken at line IV of FIG. 3;

FIG. 5 is a top perspective view of the vehicle headrest, having a first post inserted through a pair of post holes in a body portion of the headrest;

FIG. 6 is a top perspective view of the vehicle headrest, showing a portion of the hollow support within the injection cavity of the headrest;

FIG. 7 is a top perspective view of the vehicle headrest, showing a first portion of the hollow support extending within the injection cavity;

FIG. 8 is an exploded top perspective view of the vehicle headrest, a first mold piece, and a second mold piece;

FIG. 9 is a side cross-sectional view of the vehicle headrest positioned between the first mold piece and the second mold piece;

FIG. 10 is a side cross-sectional view of the vehicle headrest between the first mold piece and the second mold piece, showing a foam substrate injected into a cavity of the headrest; and

FIG. 11 is a side cross-sectional view of the vehicle headrest positioned between the first mold piece and the second mold piece, showing the body portion injected with the foam substrate to a predetermined shape.

### DETAILED DESCRIPTION

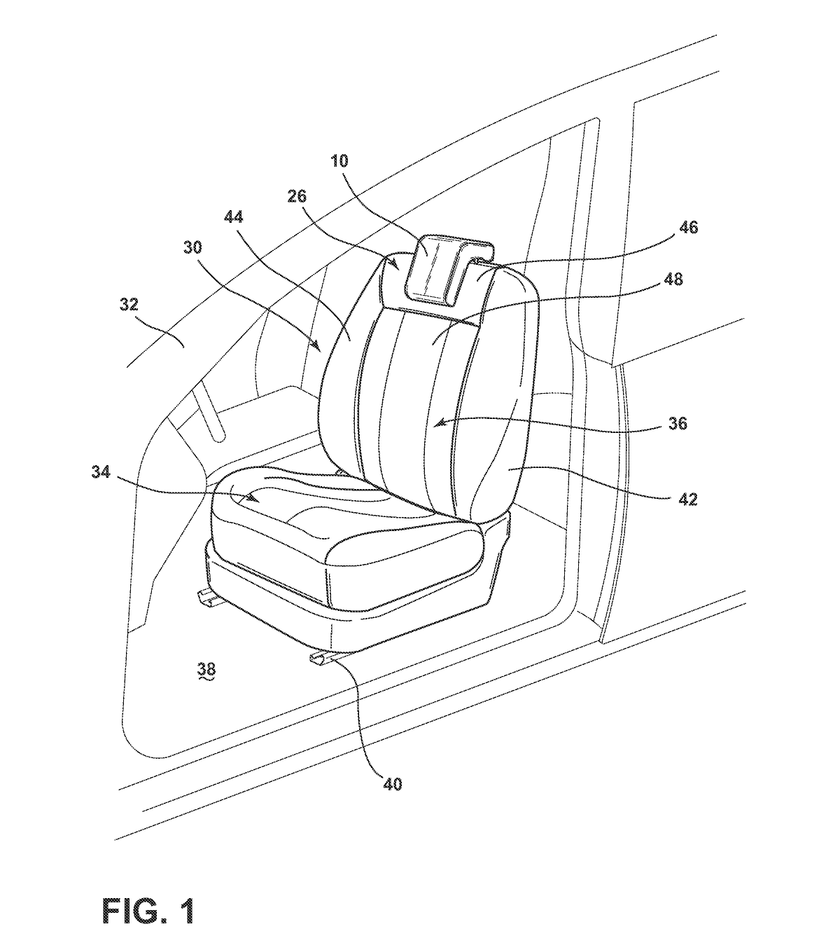

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIGS. 1-11, reference numeral 10 generally designates a vehicle headrest 10 that includes a cover stock shell 12 enclosing an injection cavity 14. A hollow support 16 has a first portion 18 that extends within the injection cavity 14 and includes a dispensing feature 20. A second portion 22 of the support 16 includes a securing feature 24 for engaging an attachment structure 26. A foam substrate 28 is disposed within the injection cavity 14. The foam substrate 28 is delivered to the injection cavity 14 within the support 16 through the dispensing feature 20.

Referring now to FIG. 1, a vehicle seating assembly 30 having one embodiment of the vehicle headrest 10 is positioned in a driver side location of a vehicle 32. The vehicle seating assembly 30 includes a seat 34 pivotally coupled with a seatback 36. The seat 34 is slidably coupled with a floor 38 of the vehicle 32 about a track assembly 40. The track assembly 40 is configured to allow the vehicle seating assembly 30 to be adjusted in a forward and a rearward direction relative to the vehicle 32. It is understood that the vehicle seating assembly 30 may be positioned at various locations through the vehicle 32 other than the illustrated position, such as passenger side location, a mid-row location, and rear seat location. It is also conceivable that the seat 34 may not include the track assembly 40 and alternatively may be fixedly coupled with the floor 38 of the vehicle 32.

As further illustrated in FIG. 1, the seatback 36 of the seating assembly 30 includes a first side support 42 and a second side support 44 that pivotally couple with a rear portion of the seat 34 and extend upward from the seat 34 to a top portion 46 of the seatback 36. The seatback 36 also includes a suspension assembly that spans between the first and second side supports 42, 44 and has a cushion 48 and an upholstery material disposed over the cushion 48 substantially enclosing the suspension assembly. The top portion 46 of the seatback 36 extends between the first and second side supports 42, 44 to define a seatback structure. The headrest 10 is removably and adjustably coupled with the top portion 46 of the seatback 36 and is substantially centered between the first and second side supports 42, 44. Accordingly, the attachment structure 26, as illustrated, includes the seatback 36, and more specifically, the upper portion of the seatback 36. It is conceivable that the seatback 36 may be alternatively shaped and constructed with various materials as generally understood in the art. It is also conceivable that the attachment structure 26 may include a rear bulkhead of a vehicle passenger compartment, a rear dash of a passenger car, a rear wall of a truck cabin, or other conceivable vehicle attachment structures for the headrest 10.

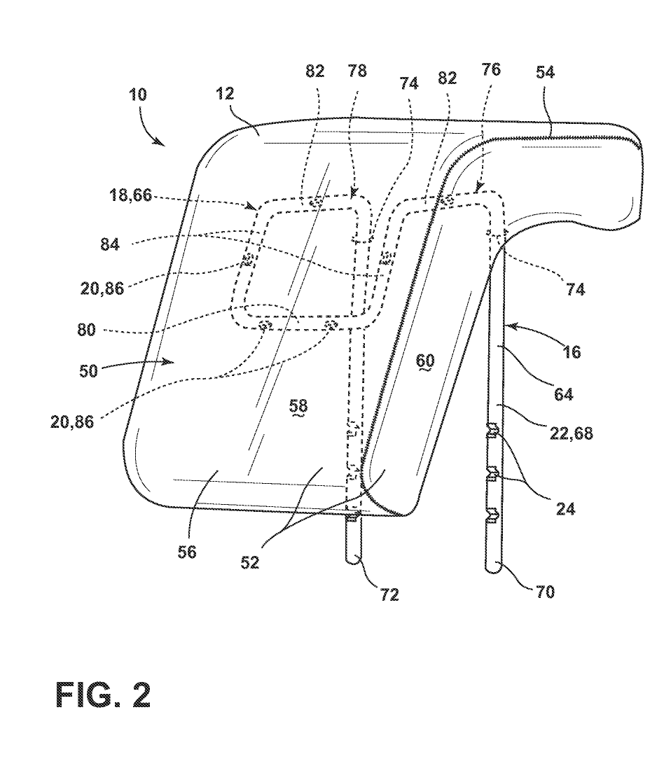

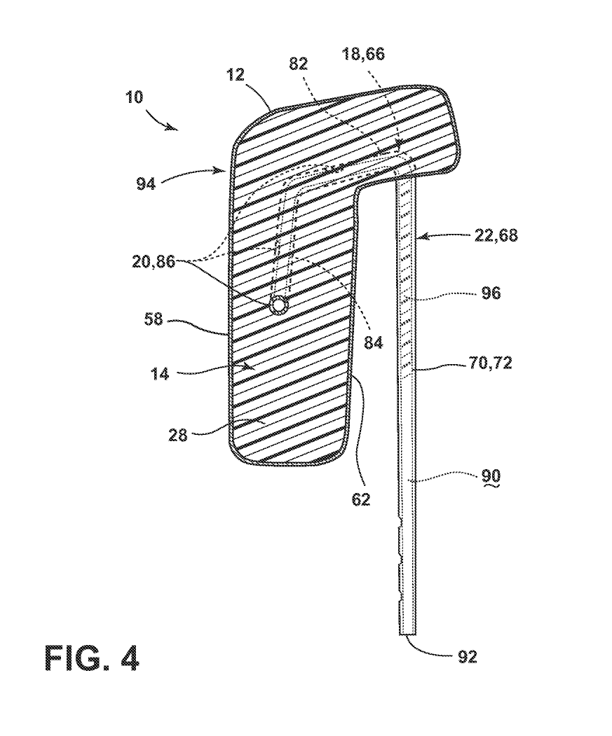

As shown in the embodiment illustrated in FIG. 2, the headrest 10 generally has a body portion 50 positioned above and supported by the support 16. The body portion 50 includes the cover stock shell 12 that substantially encloses the injection cavity 14 (FIG. 4). The cover stock shell 12 is comprised of panels of cover stock material 52 that are joined at a permeable seam 54 to form the cover stock shell 12. The panels of cover stock material 52 may include a fabric material, a leather material, a vinyl material, a synthetic material, or other vehicle upholstery materials, and further may include a substantially similar material to the upholstery material covering the seatback 36 and the seat 34 of the vehicle seating assembly 30. The body portion 50 has an exterior surface 56 including a head support surface 58 that is generally forward facing to support a passenger's head. The exterior surface 56 of the body portion 50 also has opposing side surfaces 60 and a rear surface 62 to define an exterior portion 68 of the cover stock shell 12. A portion of the permeable seam 54 extends between the head support surface 58 and the side surfaces 60 and is formed from joining the panels of cover stock material 52. It is conceivable that the permeable seam 54 may include a stitching formed with a thread element comprising cotton, polyester, nylon, metal wire, monofilament, or combinations thereof. The permeable seam 54 may also conceivably include other fastening features, such as an adhesive or a heat welded bond. The spacing and permeability of the permeable seam 54 between the panels of cover stock material 52 may be increased when using non-permeable cover stock material, such as leather material. It is also conceivable that the panels of cover stock material 52 may be alternative shaped or constructed, such that the permeable seam 54 may also be eliminated or alternately configured.

The embodiment shown in FIG. 2 also illustrates the support 16 that extends between the body portion 50 and the attachment structure 26. The support 16 includes a hollow support post 64 with a U-shaped interior portion 66 extending within the injection cavity 14 of the body portion 50 that corresponds with the first portion 18 of the support 16. An exterior portion 68 of the support post 64, corresponding with the second portion 22 of the support 16, extends away from the body portion 50 to couple with the attachment structure 26. The exterior portion 68 of the support post 64 includes a first post 70 and a second post 72 that exit the injection cavity 14 through post holes 74 formed in the cover stock shell 12.

As illustrated in FIG. 2, the interior portion 66 of the support post 64 extends forward from the post holes 74 to generally conform to the contour of the body portion 50 and provide structural support to the head support surface 58 and other portions of the overall body portion 50. More specifically, the interior portion 66 includes a first side segment 76, a second side segment 78, and a central member 80 extending between the first and second side segments 76, 78. A rear portion of the first and second side segments 76, 78 extend generally orthogonally forward from the first post 70 and the second post 72, respectively, defining a substantially horizontal member 82. The first and second side segments 76, 78 proceed to extend down from the horizontal member 82 at an angle substantially parallel to the head support surface 58 of the cover stock shell 12, each defining a slanted member 84. The slanted members 84 couple with the central member 80 that extends generally orthogonally therebetween. It is contemplated that the interior portion 66 of the support post 64 may be alternatively arranged within the injection cavity 14 to provide support to the body portion 50, such as providing a serpentine pattern or coupling with an additional support structure disposed therein.

Still referring to FIG. 2, the dispensing feature 20 on the first portion 18 of the support 16 includes a plurality of dispensing apertures 86 disposed on the interior portion 66 of the support post 64. As shown, the horizontal members 82 and the slanted members 84 of the first and second side segments 76, 78 each include a single dispensing aperture 86. The central member 80, however, includes two dispensing apertures 86. The dispensing apertures 86 are generally forward facing and evenly spaced on the support post 64. It is conceivable that the plurality of the dispensing apertures 86 may be alternatively positioned on the first portion 18 of the support 16 to provide a desired disbursement and flow rate of the foam substrate 28 (FIG. 4) that is injected into the injection cavity 14, as described in more detail below.

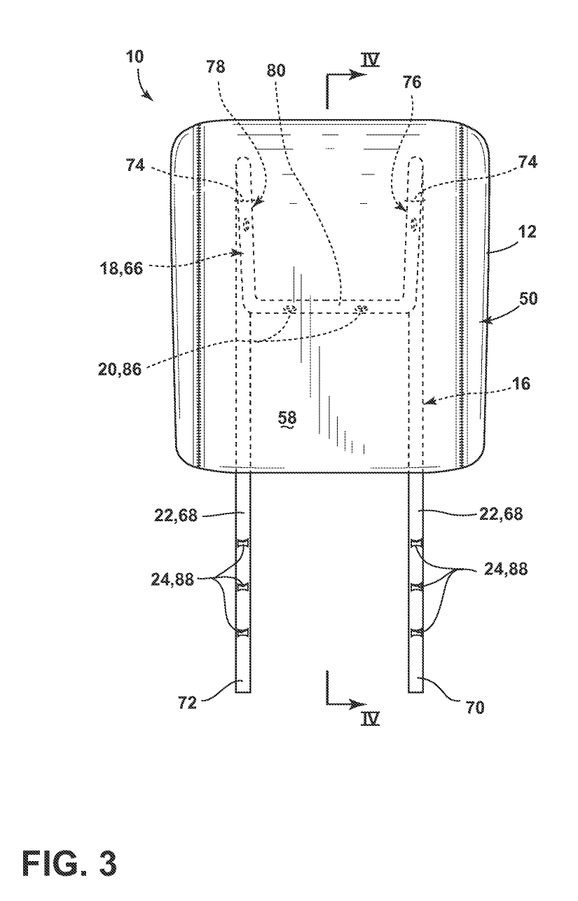

As shown in FIG. 3, the first and second side segments 76, 78 of the first portion 18 of the support 16 taper outward as they extend upward to the post holes 74 in the cover stock shell 12. From the post holes 74, the first post 70 and the second post 72 of the exterior portion 68 extend downward in substantially parallel alignment, exiting the injection cavity 14 (FIG. 4) through the post holes 74. The securing feature 24 on the second portion 22 of the support 16 includes a plurality of notches 88 spaced along the longitudinal extent of the first and second support posts 70, 72. The notches 88 are formed and spaced at substantially equal locations on the first and second post 70, 72, such that a single notch 88 on each of the first and second support posts 70, 72 may be simultaneously and releasably engaged by a spring biased retention element on the attachment structure 26 (FIG. 1). The notches 88 may be released from engagement with the retention element for removing the headrest 10 or adjusting the height of the body portion 50 of the headrest 10 relative to the seatback 36, in the illustrated embodiment, and re-engaging the retention element. As shown, the first and second support posts 70, 72 each include three notches 88 evenly spaced on a forward facing portion of the longitudinal extent of the first and second support posts 70, 72. It is contemplated that the securing feature 24 may include various arrangements and quantities of notches 88 or other deformations or protrusions on the second portion 22 of the support 16 to adjustably engage the attachment structure 26 (FIG. 1).

As shown in FIG. 4, the support 16 includes a hollow portion having a tubular channel 90 extending within a longitudinal extent of the support 16. The tubular channel 90 extends from a distal end 92 of the first and second support post 70, 72 to the plurality of dispensing apertures 86 on the first portion 18 thereof. As also illustrated in FIG. 4, the foam substrate 28 disposed within the injection cavity 14 defines a predetermined shape 94 of the body portion 50 of the headrest 10. The foam substrate 28 generally surrounds the first portion 18 of the support 16, such that the cross-sectional shape of the body portion 50 includes a shape that follows the contour of the slanted member 84 and the horizontal member 82 of the first portion 18. The cover stock shell 12 substantially encloses the foam substrate 28, defining a peripheral boundary of the predetermined shape 94 of the headrest 10. The foam substrate 28 also occupies the tubular channel 90 of the support post 64, defining a core portion 96 of the foam substrate 28 within the tubular channel 90. The core portion 96 provides added rigidity and strength to the hollow support 16.

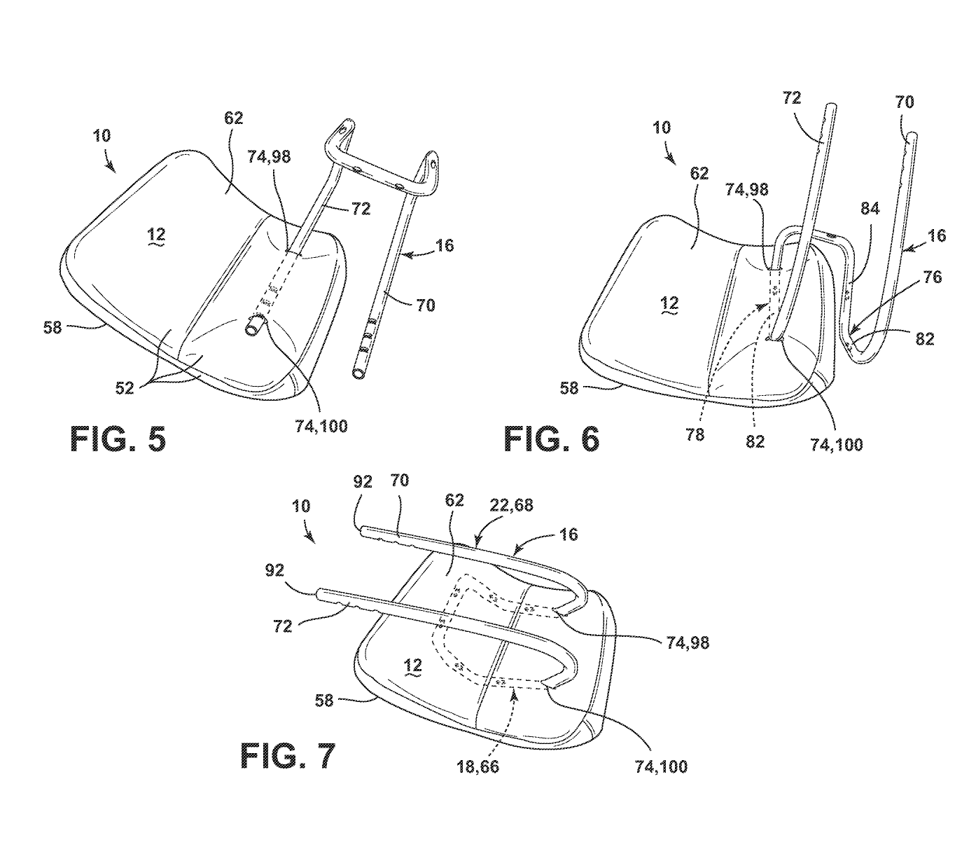

Upon forming and assembling the headrest 10, the cover stock shell 12 is sewn from the panels of cover stock material 52 to enclose the injection cavity 14 (FIG. 4). A first post hole 98 and a second post hole 100 are cut, stamped, or otherwise formed in the cover stock shell 12 away from the head support surface 58 and proximate the rear surface 62 of the cover stock shell 12. As shown in FIG. 5, the support 16 is threaded through the cover stock shell 12. Accordingly, the second support post 72 is inserted through the first post hole 98, into the injection cavity 14 (FIG. 4), and out through the second post hole 100 in the cover stock shell 12.

As illustrated in FIG. 6, the support 16 continues to be inserted through the post holes 74 such that the second side segment 78, including the horizontal member 82 and a portion of the slanted member 84, are inserted into the injection cavity 14 (FIG. 4). The support 16 is further inserted through the first post hole 98 to position the entire first portion 18 of the support 16 into the injection cavity 14. Upon complete insertion, as shown in FIG. 7, the first portion 18 of the support 16 centrally occupies the injection cavity 14 and the first and second support posts 70, 72 of the second portion 22 of the support 16 have a substantially equal length extending from the first and second post holes 98, 100 to the distal ends 92.

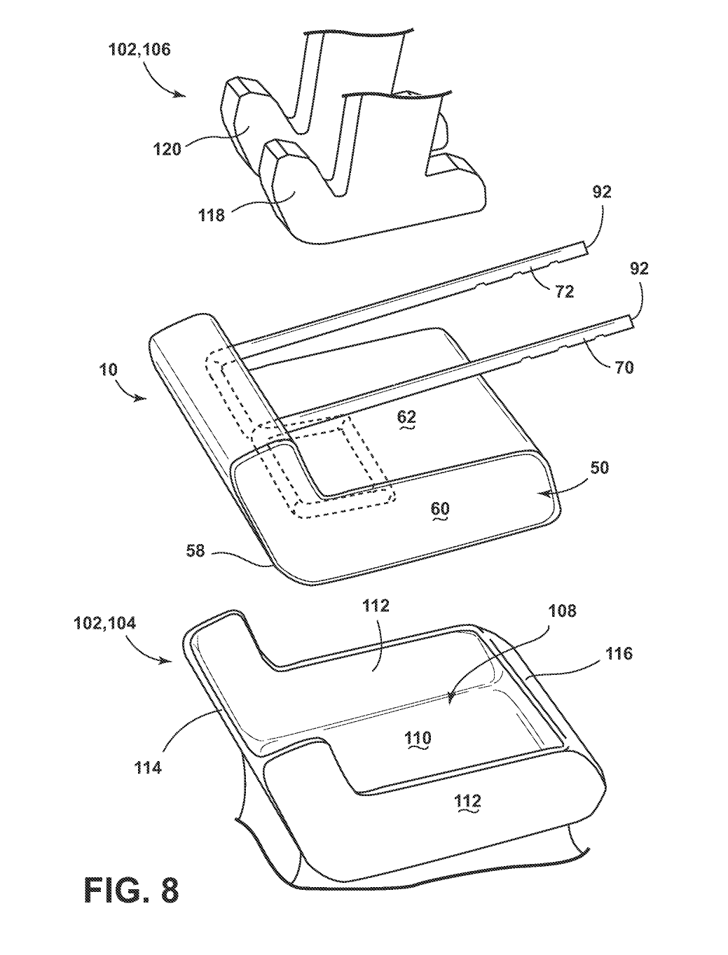

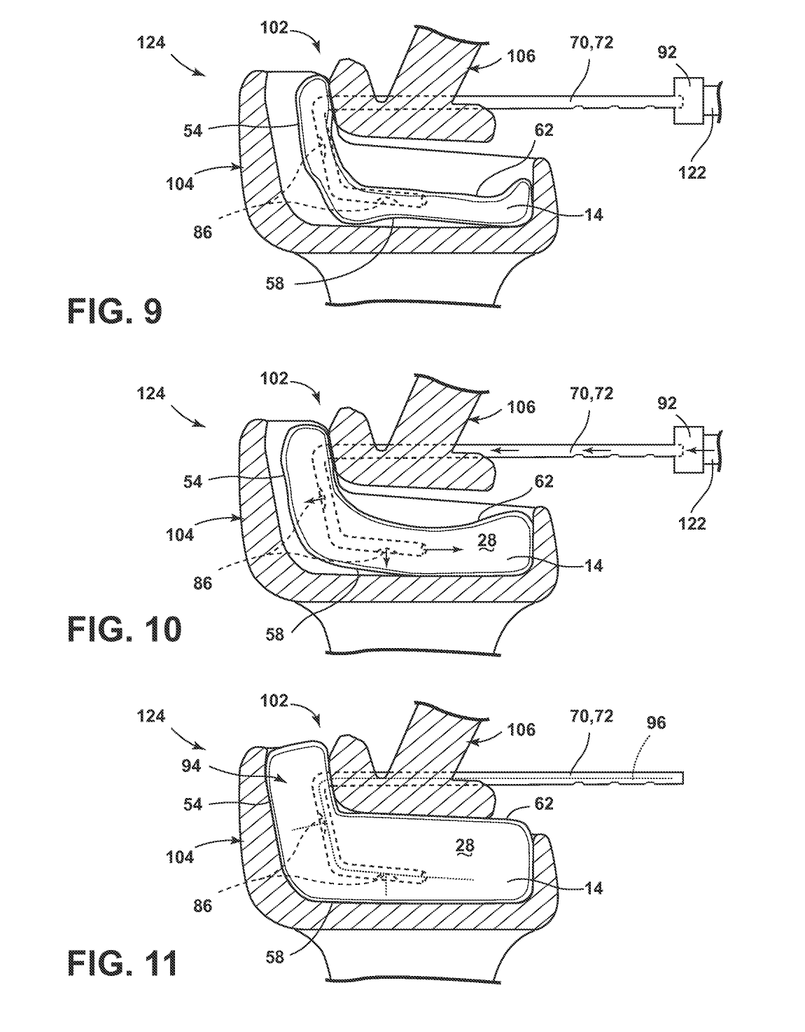

Referring now to FIG. 8, an injection mold 102 having a first mold piece 104 and a second mold piece 106 is configured to substantially enclose the body portion 50 of the headrest 10 and expose at least the distal ends 92 of the first and second support posts 70, 72. The first mold piece 104 includes a recess 108 having a shape corresponding with the predetermined shape 94 of the body portion 50 of the headrest 10. Accordingly, the recess 108 includes a base floor 110 have a substantially horizontal surface to correspond with the head support surface 58 of the body portion 50. Two side walls 112 extend upward from opposing sides of the base floor 110 in substantially parallel alignment, corresponding with the side surfaces 60 of the body portion 50 of the headrest 10. A top wall 114 and a bottom wall 116 also extend upward from the base floor 110 and extend between the side walls 112 to define and enclose the shape of the recess 108. The second mold piece 106 includes a first arm 118 and a second arm 120 that are configured to abut the rear surface 62 of the body portion 50 and allow the distal ends 92 of the first and second support posts 70, 72 to be accessible to injector hoses 122 (FIG. 9). It is contemplated that the first and second mold pieces 104, 106 may be alternatively shaped or constructed to correspond with the headrest 10 or an alternatively shaped or constructed headrest 10.

As illustrated in FIGS. 9-10, the body portion 50 of the headrest 10 is positioned in the recess 108 of the first mold piece 104 and the second mold piece 106 is positioned above the rear surface 62 of the body portion 50, defining an injection position 124. In the injection position 124 the distal ends 92 of the first and second support posts 70, 72 are removably coupled with the injector hoses 122. As shown in FIG. 10, the foam substrate 28 is injected through the injector hoses 122 and flows into the injection cavity 14 of the body portion 50 through the first and second support posts 70, 72. It is contemplated that the foam substrate 28 may include an open cell foam, a closed cell foam, or other injectable substrates. The foam substrate 28 fills the injection cavity 14 as it enters the cavity 14 through the dispensing apertures 86. The permeable seams 54 on the cover stock shell 12 are configured to exhaust air from the cavity 14 as the foam substrate 28 is injected into the cavity 14, thereby permitting the foam substrate 28 to substantially occupy the entire cavity 14 within the body portion 50 of the headrest 10.

Upon substantially occupying the entire injection cavity 14, as shown in FIG. 11, the foam substrate 28 is permitted to cure for a select period of time within the cavity 14, thereby further adhering and maintaining the predetermined shape 94 of the body portion 50 as defined by the recess 108 of the first mold piece 104 and the second mold piece 106. The injection hoses 122 are then removed from the first and second support posts 70, 72 and the second mold piece 106 is removed from the rear surface 62 of the body portion 50, allowing the headrest 10 to be removed from the mold 102. After injection, the foam substrate 28 substantially occupies the tubular channel 90 of the support posts 64 to provide added structural support to the support posts 70, 72. Also, the foam substrate 28 occupies the injection cavity 14 of the body portion 50, providing cushioned support to the passenger's head while resting on and depressing the head support surface 58 rearward.

Once the headrest 10 is removed from the mold 102, the body portion 50 maintains the predetermined shape 94 and lacks any visible injection apertures. More specifically, the cover stock shell 12 does not contain any holes or apertures aside from the permeable seam 54 and the first and second post holes 98, 100 containing the first and second support posts 70, 72, respectively. As such, the headrest 10 is provided with a visually appealing cover stock shell 12 that lacks imperfections that may be caused by directly injecting the foam substrate 28 through an auxiliary injection aperture in the cover stock shell 12.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A vehicle headrest comprising:
a cover stock shell enclosing an injection cavity;
a hollow support including:
a first portion extending within the injection cavity and having a dispensing feature; and
a second portion having a securing feature for engaging an attachment structure; and
a foam substrate disposed within the injection cavity, wherein the foam substrate is delivered to the injection cavity within the hollow support and through the dispensing feature.

2. The vehicle headrest of claim 1, wherein the cover stock shell includes a fabric material that has at least one permeable seam, and wherein the foam substrate defines a predetermined shape of the headrest.

3. The vehicle headrest of claim 1, wherein the attachment structure includes an upper seatback, and wherein the securing feature includes a plurality of notches spaced along the longitudinal extent of the support post for adjusting the height of the headrest relative to the upper seatback.

4. The vehicle headrest of claim 1, further comprising:
a tubular channel extending within the hollow support from a distal end of the hollow support to the dispensing aperture, wherein the foam substrate is delivered to the injection cavity via the tubular channel.

5. The vehicle headrest of claim 1, wherein the first portion of the hollow support includes a U-shape and the second portion of the hollow support includes at least two posts extending from the headrest.

6. The vehicle headrest of claim 5, wherein the dispensing feature includes a plurality of apertures that extend to a hollow portion of the hollow support, and wherein the foam substrate is discharged from the hollow portion via the plurality of apertures.

7. The vehicle headrest of claim 1, wherein the cover stock shell includes at least one permeable seam that is configured to exhaust air from the injection cavity when the foam substrate is delivered to the injection cavity.

8. A vehicle headrest comprising:
a body portion enclosing a cavity and having a post hole;
a hollow support post extending through the post hole and having a first portion within the cavity and a second portion for engaging an attachment structure; and
a foam substrate injected into the cavity via the support post to occupy the injection cavity in a predetermined shape.

9. The vehicle headrest of claim 8, further comprising:
a securing feature on the second portion of the support post for adjustably engaging the body portion with the attachment structure.

10. The vehicle headrest of claim 9, wherein the attachment structure includes a seatback, and wherein the securing feature is configured to adjust the longitudinal height of the body portion relative to the seatback.

11. The vehicle headrest of claim 8, further comprising:
a hollow portion extending within the support post from the first portion within the cavity to a distal end of the support post proximate the second portion.

12. The vehicle headrest of claim 8, further comprising:
a plurality of dispensing apertures on the first portion of support post, wherein the foam substrate is delivered to the injection cavity through the plurality of dispensing apertures.

13. The vehicle headrest of claim 8, wherein the first portion of the support post includes a U-shaped portion, and wherein the second portion of the support post includes a pair of rods extending from the cavity.

14. The vehicle headrest of claim 13, wherein the U-shaped portion of the support post includes a plurality of dispensing apertures, and wherein a tubular channel extends from the plurality of dispensing apertures to a distal end of the pair of rods to deliver the foam substrate to the cavity.

15. A method for forming a headrest comprising:
providing a cover stock shell that encloses a cavity and includes a post hole;
inserting a hollow support through the post hole and into the cavity, defining a first portion having a dispensing aperture within the cavity and a second portion for engaging an attachment structure and having an injection aperture; and
injecting a foam substrate into the cavity via the support to form a body portion.

16. The headrest of claim 15, wherein the support includes a hollow portion extending from the dispensing aperture to the injection aperture, and wherein the foam substrate is delivered to the cavity through the hollow portion of the support.

17. The headrest of claim 15, wherein the cover stock shell includes a leather material that has at least one permeable seam, and wherein the permeable seam is configured to exhaust air from the cavity when the foam substrate is injected into the cavity.

18. The headrest of claim 15, wherein the injection aperture is disposed on a distal end of the second portion of the support, and wherein the foam substrate enters the support through the injection aperture and exits the support through the dispensing aperture.

19. The headrest of claim 15, further comprising:
forming a predetermined shape of the body portion with a first mold piece substantially enclosing a head support surface of the body portion and a second mold piece substantially enclosing a rear surface of the body portion.

20. The headrest of claim 19, further comprising
removing the second mold piece and removing the body portion from the first mold piece.
